(19) United States
(12) Patent Application Publication
(10) Pub. No.: US 2008/0049999 A1
(43) Pub. Date: Feb. 28, 2008

(54) Computer Aided Detection of Bone Metastasis

(75) Inventors: Anna Jerebko, West Chester, PA (US); Xiang Sean Zhou, Exton, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 11/845,307

(22) Filed: Aug. 27, 2007

Related U.S. Application Data
(60) Provisional application No. 60/840,620, filed on Aug. 28, 2006.

(51) Int. Cl. G06K 9/00

(52) U.S. Cl. 382/128

(57) ABSTRACT

A method for automatic detection of regions of suspicion within a region of interest includes acquiring image data sets. The region of interest is segmented within the image data sets. Each of the image data sets are co-registered to a common coordinate system. Each image data set is individually examined to identify the location of regions of suspicion with reference to the common coordinate system within the image data sets. Each of the image data sets are individually inspected at the locations of the identified regions of suspicion on the common coordinate system to obtain information pertaining to the regions of suspicion. It is determined, based on the obtained information pertaining to the regions of suspicion, whether the regions of suspicion are abnormalities.

### CROSS-REFERENCE TO RELATED APPLICATION

The present application is based on provisional application Ser. No. 60/840,620, filed Aug. 28, 2006, the entire contents of which are herein incorporated by reference.

### BACKGROUND OF THE INVENTION

1. Technical Field

The present disclosure relates to computer aided detection and, more specifically, to computer aided detection of bone metastasis.

2. Discussion of the Related Art

Medical imaging is the field of visualizing the internal structure of a patient subject using fields that are able to penetrate the body of the subject. Examples of common medical imaging techniques include traditional x-rays, computed tomography (CT), magnetic resonance (MR), ultrasound, positron emission tomography (PET), and the like.

While medical imaging techniques such as traditional x-rays provide a two-dimensional image, many modern medical imaging techniques, such as CT, provide a three-dimensional image by combining multiple two-dimensional image slices into a three-dimensional computer model that can be viewed from a wide variety of angles and depths.

By imaging the internal structure of the patient subject, injury, disease and congenital defect may be identified and treated. For example, a patient's bone structure may be images so that a clinician, for example, a radiologist, may look for the presence of a bone lesion that may be a metastasis.

Traditionally, medical imaging techniques resulted in the display of a medical image, either on a film or on a computer display allowing a clinician to examine the medical image to render a diagnosis.

However, it is possible for clinicians to miss what may be very small abnormalities in medical images and thus abnormalities such as bone metastasis may go unnoticed. Because diseases such as cancers are most treatable at early stages, early detection of abnormalities may be lead to reduced mortality and morbidity.

Moreover, proper review of medical images may take a long time. With the increased costs of medical care, the increased use of medical imagery, and the limited availability of qualified practitioners, it is becoming increasingly burdensome for qualified medical practitioners to properly review each and every medical image.

This problem is compounded by the added precision of modern medical imaging devices that are able to capture images at high resolutions and in three dimensions. The higher resolution means that the practitioner must more closely analyze each section of the medical image to determine if early signs of disease are visible from among the captured pixels. Moreover, three-dimensional medical images may require careful examination at many different levels of depth. In fact, as the pixel density of medical images increases due to higher resolution scans and more image slices, manually examining all of the collected data may be nearly impossible for a medical practitioner.

### SUMMARY

A method for automatic detection of regions of suspicion within a region of interest includes acquiring a plurality of image data sets. The region of interest is segmented within one or more of the image data sets. Each of the image data sets are co-registered to a common coordinate system. Each image data set is individually examined to identify the location of one or more regions of suspicion with reference to the common coordinate system within one or more of the image data sets. Each of the image data sets are individually inspected at the locations of the identified regions of suspicion on the common coordinate system to obtain information pertaining to each of the regions of suspicion. It is determined, based on the obtained information pertaining to the regions of suspicion, whether each of the regions of suspicion is an abnormality.

A method for automatic detection of bone lesions within a computer aided detection system includes acquiring a plurality of image data sets including multiple image scans and multiple data sequences. One or more bones are segmented within one or more of the image data sets. Each of the image data sets are co-registered to a common coordinate system with reference to the one or more bones. Each image data set is individually examined to identify the location of one or more lesion candidates with reference to the common coordinate system within one or more of the image data sets. Each of the image data sets are individually inspected at the locations of the identified lesion candidates on the common coordinate system to obtain information pertaining to each of the lesion candidates. It is determined, based on the obtained information pertaining to the lesion candidates, whether each of the lesion candidates is an actual lesion. Each lesion candidate that has been determined to be an actual lesion is categorized according to the obtained information pertaining to the lesion candidates.

A computer system includes a processor and a program storage device readable by the computer system, embodying a program of instructions executable by the processor to perform method steps for automatic detection of bone lesions. The method includes acquiring a plurality of image data sets including multiple image scans and multiple data sequences. Each image data set is individually examined to identify the location of one or more lesion candidates with reference to the common coordinate system within one or more of the image data sets. Each of the image data sets is individually inspected at the locations of the identified lesion candidates on the common coordinate system to obtain information pertaining to each of the lesion candidates. It is determined, based on the obtained information pertaining to the lesion candidates, whether each of the lesion candidates is an actual lesion.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 is a flow chart illustrating a method for computer aided detection according to an exemplary embodiment of the present invention;

FIG. 2 illustrates a plurality of image data sets where the spinal cord has been segmented according to an exemplary embodiment of the present invention;

FIG. 3 is a close-up view of an image data set showing multiple detected lesion candidates according to an exemplary embodiment of the present invention; and

FIG. 4 shows an example of a computer system capable of implementing the method and apparatus according to embodiments of the present disclosure.

### DETAILED DESCRIPTION OF THE DRAWINGS

In describing the exemplary embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Modern medical imaging techniques, for example CT scans and MR scans, generally involve sets of multiple scans taken at different times and/or from different positions. Moreover, even a single scan, for example, an MR scan, may include multiple data sequences.

In MR imagery, the structure to be imaged is subjected to a strong electro-magnetic (EM) field. The EM field elevates the magnetic moment of the atomic nuclei of the scanned matter to an excited state and the rate in which the magnetic moments return to equilibrium (relax), a characteristic that is highly indicative of the particular form of matter being scanned, is closely monitored. By analyzing these relaxation times, the forms of matter within the scanned structure may be imaged.

There are several relaxation times that are relevant to MR imaging. For example, T1, also known as spin-lattice relaxation time, is defined as the component of relaxation which occurs in the direction of the ambient magnetic field. This generally comes about by interactions between the nucleus of interest and unexcited nuclei in the environment and ambient electric fields. T1 is measured as the time required for the magnetization vector to be restored to 63% of its original magnitude.

T2, also known as spin-spin relaxation time, is defined as the component of relaxation which occurs perpendicular to the ambient magnetic field. This relaxation is dominated by interactions between spinning nuclei that are already excited. T2 is measured as the time required for the transverse magnetization vector to drop to 37% of its original magnitude after its initial excitation.

T2* is the characteristic time constant that describes the decay of transverse magnetization, taking into account the inhomogeneity in static magnetic fields and the spin-spin relaxation in the human body. T2* is thus influenced by magnetic field gradient irregularities. T2* is increased with iron deposition.

The observation of each set of relaxation times constitutes a separate data sequence. For example, spin-lattice relaxation time (T1) may constitute a first data sequence while transverse magnetization decay time (T2*) may constitute a second data sequence.

Other exemplary data sequences include the Short Tau Inversion Recovery (STIR) and Half-Fourier Single-Shot Turbo Spin-Echo (HASTE).

Moreover, multiple scans may be taken in sequence. For example, a patient may undergo a first MR scan, followed by a second MR scan a short time later. For example, it is common for the same structure to be imaged several times, in overlapping image sections such as a head image, torso image, pelvis image, etc. Each scan may involve a different resolution and/or other scan parameters may be varied. Subtle and large movements may also affect the scan. For example, the patient may shift position between scans and/or internal organs such as the heart and lungs may be imaged in varying stages of contraction.

In each scan and/or data sequence, different information may be captured. Accordingly, a bone marrow lesion that may be hidden in one scan/data sequence may be observable from another scan/data sequence. Moreover, difference scans/data sequences may provide different insights into a particular lesion. For example, a first scan/data sequence may provide the best indication of the presence of a lesion, but characterization of the lesion may require reference to one or more other scans/data sequence. In fact, the information revealed about a lesion from the first scan/data sequence may dictate which other scans/data sequences may be most useful to refer to in establishing or confirming a diagnosis.

Accordingly, exemplary embodiments of the present invention utilize multiple scans and/or multiple data sequences to identify and/or classify a lesion and/or other region of interest. Detection of a lesion and/or other region of interest may thus be performed automatically by reference to multiple scans and/or data sequences.

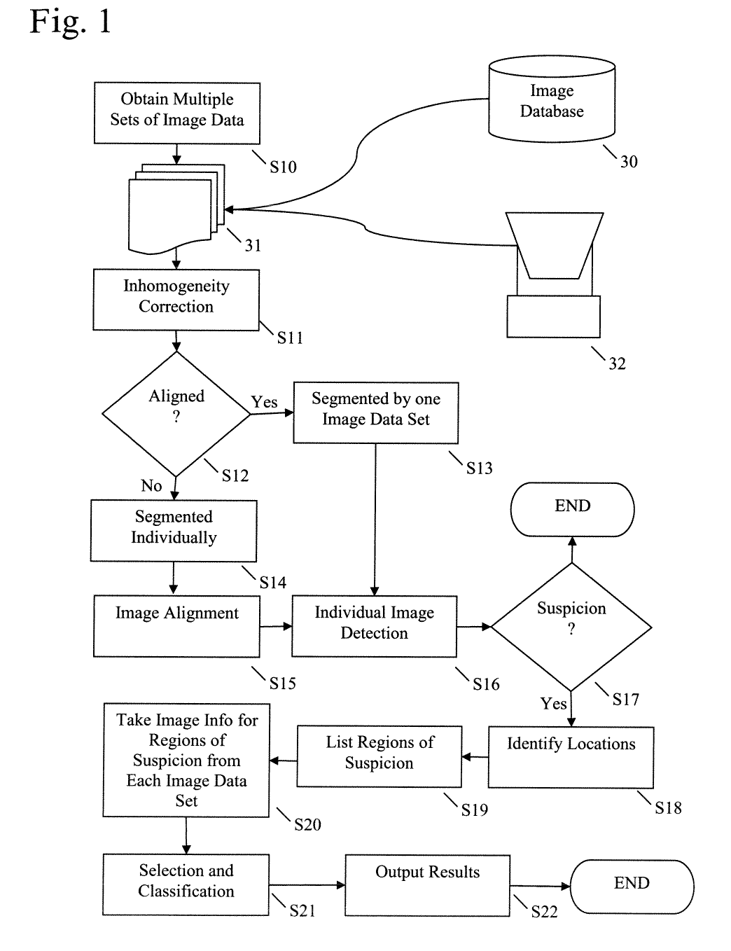

FIG. 1 is a flow chart illustrating a method for computer aided detection according to an exemplary embodiment of the present invention. First, multiple sets of image data 31 may be obtained (Step S10). The image data sets 31 may be obtained from a medical image database 30 or directly from an image scanner 32 such as an MRI or a CT scanner. Each image data set may include an image scan and/or a data sequence. Accordingly, multiple sets of image data may include, for example, several scans taken at different resolutions or under other different parameters or at different times, several overlapping scans, scans captured from multiple different scanning modalities, for example, some MR scans and some CT scans, and/or several data sequences.

For example, different data sequences such as a T1 data sequence, a T2 data sequence, and a T2* data sequence may each comprise an image data set. For example, different scan orientations such as a coronal scan, a saggital scan, a head scan, a torso scan, a pelvis scan, and a high-resolution spine image scan may each comprise an image data set.

The image data may be obtained, for example, from a medical image device such as an MR scanner or a CT scanner. Alternatively, the image data may be obtained from a medical image database.

Once obtained, intensity inhomogeneity correction may be performed for all image data under consideration (Step S11). Intensity inhomogeneity may appear as a sudden shift in pixel intensities within a medical image. Intensity inhomogeneity may be caused, for example, when different magnetic coils of an MRI provide different magnetic field strengths. Intensity inhomogeneity correction may thus be performed to reduce or eliminate the shifts in pixel intensity that are caused by factors other than the internal structure of the patient being imaged.

At this point, the region of interest, for example, one or more bones, has been imaged in multiple sets of image data. If the image data are well aligned (Yes, Step S12) then the region of interest, for example, one or more bones, may be segmented in one set of image data, for example, the set of image data that includes the greatest portion of the region of interest and this image segmentation may be applied to each of the other sets of image data that are well aligned (Step S13). Alternatively, if the image data are not well aligned (No, Step S12) then the region of interest, for example, one or more bones, may be segmented individually for each set of image data (Step S14). Some combination of these various alternatives may be used. For example, if there are some image data sets that are well aligned and other image data sets that are not well aligned, then those image data sets that are well aligned may be segmented with respect to one of the image data sets while those image data sets that are not well aligned may be individually segmented.

Segmentation of the region of interest may involve, for example, isolation of the image data involving the region of interest and removal of data not within the region of interest. The result of segmentation may be an image of only the region of interest, for example, the one or more bones of interest.

Where multiple image data sets are overlapping, segmentation may be performed either before or after the overlapping multiple image data are combined.

Where the image data are not well aligned (No, Step S12) an image alignment step may be performed (Step S15) after segmentation (Step S14). Image alignment may be performed based on the region of interest. For example, where the region of interest is one or more bones, image alignment may be performed with reference to the one or more bones of interest.

Alternatively, a general image alignment may be performed without regard to any particular region of interest.

Detection may then be performed on each image data set individually to identify regions of suspicion, for example, lesion candidates (Step S16). The region of suspicion or lesion candidate may be, for example, a bone marrow metastases candidate. Where the region of interest is one or more bones, a region of suspicion may be an area identified as being a potential lesion. Because detection is performed individually for each image data set, data from individual scans and data from individual data sequences may be separately processed for detection of regions of suspicion.

Detection may be automatically performed for each image data set either in series (e.g. one image data set at a time) or in parallel (e.g. multiple image data sets are processed at the same time) however, regardless of whether data sets are processed in series or in parallel, each data set is processed individually.

Where one or more regions of suspicion are detected in a particular image data set (Yes, Step S17) the location of the one or more regions of suspicion are identified in the other image data sets (Step S18). Where no regions of suspicion are detected (No, Step S17) the process may end.

After detecting the presence of regions of suspicion from all image data sets, the locations of the discovered regions of suspicion are added to a list of discovered regions of suspicion (Step S19). Image information at the location of each of the discovered regions of suspicion are taken from each of the image data sets (Step S20) so that a database is formed including the location of each discovered regions of suspicion and the image information found at that location in each image data set.

Selection and classification is them performed for each regions of suspicion based on the image information from each image data set at the location of the regions of suspicion (Step S21). Selection and classification is an automated process by which each region of suspicion is examined to determine whether it is an abnormality (for example, a lesion) or a false positive, and if it is an abnormality, what sort of abnormality it is.

Selection and classification may be performed either from the information of each data set individually, or a decision tree may be used to perform and confirm a diagnosis. For example, a decision tree may be used to generate a list of possible diagnoses for a given lesion candidate and may then be used to determine which image data set should be referred to in order to confirm or rule out particular possible diagnoses.

Results of selection and classification may then be outputted (Step S22) for the benefit of a medical practitioner to render a diagnosis.

For example, the following image data sets may be obtained: a T1 data sequence, a T2 data sequence, a T2* data sequence, a coronal scan, a saggital scan, a head scan, a torso scan, a pelvis scan, and a high-resolution spine image. Then, inhomogeneity correction may be performed on each of the above-named image data sets. In this example, the region of interest is the spinal cord. Here, the image data sets are not well aligned and the spinal cord is separately segmented in each image data set.

Thus information may be obtained for each region of suspicion. In performing this step, the region of suspicion may be segmented from each scan. Then, from the segmented region of suspicion, volume, shape, spherecity, spikiness and/or texture may be calculated. Then, because the same region of suspicion is separately segmented for each image, a consensus for the volume, shape and location of the region of suspicion may be calculated, for example, using averaging, information fusion, and/or robust estimation. Information fusion is a way of calculating a weighted average for the region of suspicion where weight represents a degree of confidence or uncertainty for each value from each scan.

As an alternative to separately segmenting the region of suspicion from each scan, a consensus segmentation may be calculated across each scan. Then, volume, shape, sphericity, spikiness and/or texture of the region of suspicion may be calculated from the consensus segmentation. Calculating the consensus segmentation may include calculating union, intersection, weighed summation, order-statistical filtering, or thresholding of the region of suspicion from each data set.

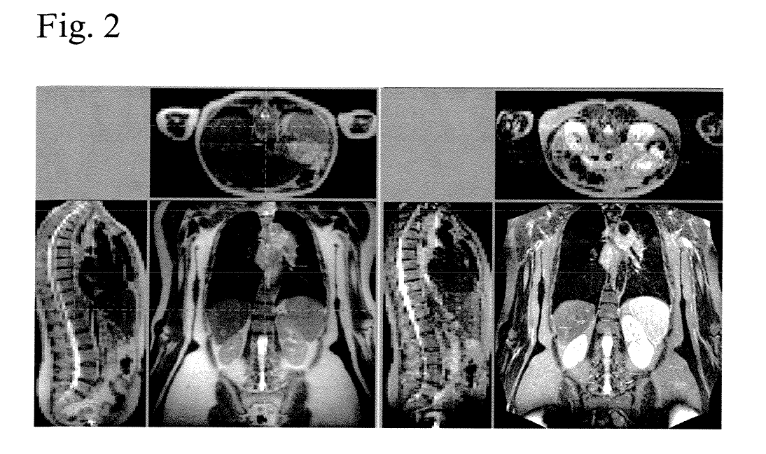

FIG. 2 shows a plurality of image data sets where the spinal cord has been segmented according to an exemplary embodiment of the present invention. Segmentation may result in isolation of the object of interest, the spinal cord. Although not shown as such, segmentation may include removing all image data that is not part of the object of interest, the spinal cord, from each image.

Image alignment is performed so that each image data set is registered against the same coordinate system so that a particular object found in one image data set may be easily found in all of the other image data sets. Here, image alignment is performed with respect to the object of interest, the spinal cord.

Lesion candidate detection may then be performed individually in each of the above-named image data sets. It is possible that a lesion observable in one of the image data sets may not be observable in other of the image data sets. Accordingly, detection may be performed individually for each image data set.

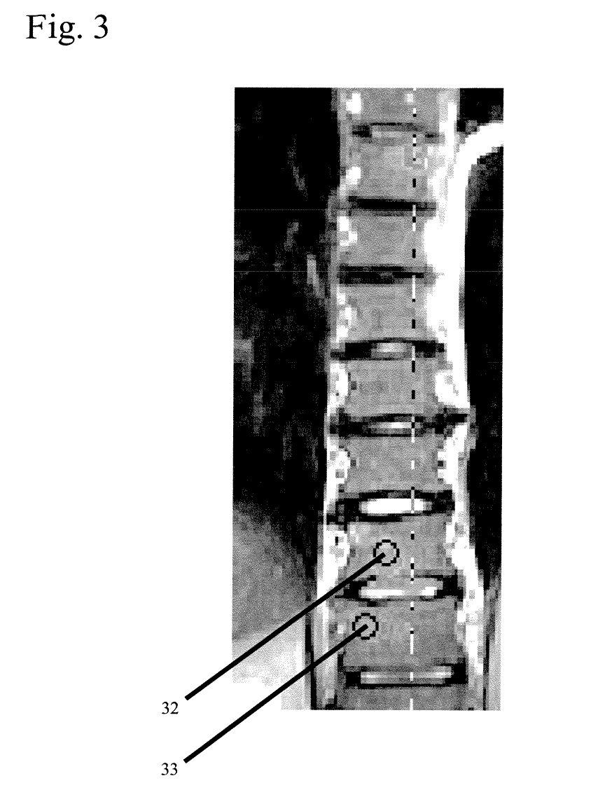

FIG. 3 is a close-up image data set showing multiple detected lesion candidates 32 and 33 according to an exemplary embodiment of the present invention. The location of each detected lesion candidate on the registered coordinate system is recorded and image information at each of these recorded locations is extracted from each of the above-named image data sets. It is possible that even an image data set in which a lesion candidate was not originally observable could provide information at the location of the lesion candidate that is useful in selection and classification of the lesion candidates. Accordingly image information at the locations of the lesion candidates are recorded from each image data set, even from those image data sets where the lesion candidates were not originally observable.

Selection and classification is then performed for each lesion candidate to determine whether there is a lesion present and if so, whether the lesion is a bone metastases or another identifiable lesion classification. Finally, a listing of all detected lesions and corresponding classifications is outputted.

Exemplary embodiments of the present invention may also include one or more other optional features. For example, automatic lesion measurement may be performed for each detected lesion so that measurement information such as lesion volume, maximum diameter (in both two and three dimensions), etc. These measurements may then be used during the selection and classification step.

Automatic lesion counting may be performed, either within the patient's whole body or within a particular region, for example, the patient's spine.

Moreover, lesion measurements may be combined across multiple scans. For example, measurements of the same lesion taken from multiple scans such as a coronal scan and a sagittal scan, and/or different pulse sequences, may be combined to provide a more complete set of measurements.

Where multiple scans encompass scans taken at different points in time, for example, two scans taken a month apart in time, change analysis may be performed on the multiple scans to follow the change in the lesion's characteristics as time progresses and/or after treatment.

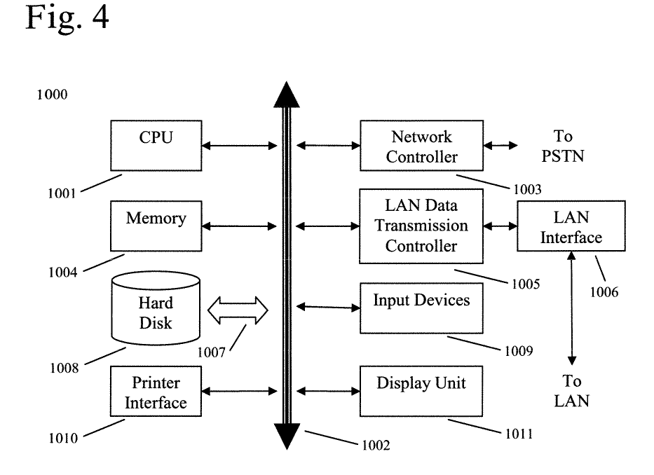

FIG. 4 shows an example of a computer system which may implement a method and system of the present disclosure. The system and method of the present disclosure may be implemented in the form of a software application running on a computer system, for example, a mainframe, personal computer (PC), handheld computer, server, etc. The software application may be stored on a recording media locally accessible by the computer system and accessible via a hard wired or wireless connection to a network, for example, a local area network, or the Internet.

The computer system referred to generally as system 1000 may include, for example, a central processing unit (CPU) 1010, random access memory (RAM) 1020, a graphical processing unit (GPU) 1030 connected to a display unit 1040, a network adapter 1070 connected to a network 1080, for example an intranet or the Internet, an internal bus 1005, and one or more input devices 1050, for example, a keyboard, mouse etc. As shown, the system 1000 may be connected to a data storage device 1060, for example, a hard disk.

The CPU 1010 may access and/or receive image data from an image acquisition station 1100 and/or a database 1090, for example, via the network 1080. The image acquisition station 1100 may include an MR scanner, a CT scanner or any other form of medical imaging device. The database 1090 may include previously acquired image data, for example, MR datasets and/or CT data sets.

The above specific exemplary embodiments are illustrative, and many variations can be introduced on these embodiments without departing from the spirit of the disclosure or from the scope of the appended claims. For example, elements and/or features of different exemplary embodiments may be combined with each other and/or substituted for each other within the scope of this disclosure and appended claims.

What is claimed is:

1. A method for automatic detection of regions of suspicion within a region of interest, comprising:
acquiring a plurality of image data sets;
segmenting the region of interest within one or more of the image data sets;
co-registering each of the image data sets to a common coordinate system;
individually examining each image data set to identify the location of one or more regions of suspicion with reference to the common coordinate system within one or more of the image data sets;
individually inspecting each of the image data sets at the locations of the identified regions of suspicion on the common coordinate system to obtain information pertaining to each of the regions of suspicion; and
determining, based on the obtained information pertaining to the regions of suspicion, whether each of the regions of suspicion is an abnormality.

2. The method of claim 1, wherein the plurality of image data sets includes multiple image scans.

3. The method of claim 1, wherein the plurality of image data sets includes multiple data sequences.

4. The method of claim 1, wherein the plurality of image scans includes an axial scan and one of a coronal scan or a saggital scan.

5. The method of claim 1, wherein the plurality of image scans includes at least one MR scan and at least one CT scan.

6. The method of claim 1, wherein the region of interest is a spinal column and the regions of suspicion are candidates for bone marrow metastases in the vertebra body.

7. The method of claim 1, wherein the step of obtaining information pertaining to each of the regions of suspicion comprises segmenting the region of suspicion and, from the segmented region of suspicion, calculating, one of volume, shape, spherecity, spikiness, or texture.

8. The method of claim 1, wherein the step of obtaining information pertaining to each of the regions of suspicion comprises finding a consensus segmentation across each data set and, from the consensus segmentation, calculating, one of volume, shape, spherecity, spikiness, or texture.

9. The method of claim 8, wherein finding the consensus segmentation includes calculating the union, intersection, weighed summation, order-statistical filtering, or thresholding of the region of suspicion from each data set.

10. The method of claim 2, wherein intensity inhomogeneity correction is performed on each image data set after the plurality of image data sets are acquired and before the region of interest is segmented.

11. The method of claim 1, wherein segmentation of the region of interest is performed within only one image data set when the image data sets are substantially aligned.

12. The method of claim 1, wherein segmentation includes isolation of the region of interest and removal of data outside of the isolated region of interest.

13. The method of claim 1, wherein information pertaining to the regions of suspicion is obtained from one or more of the image data sets where the location of the regions of suspicion are not found during individual examination.

14. The method of claim 1, additionally comprising categorizing each of the abnormalities based on the obtained information pertaining to the corresponding region of suspicion when it is determined that the region of suspicion is an abnormality.

15. The method of claim 14, wherein the abnormality is categorized according to a decision tree indicating how to narrow down a list of potential categories based on the obtained information pertaining to the region of suspicion taken from the plurality of image data sets.

16. The method of claim 1, wherein co-registration of the image data sets is performed with respect to the region of interest.

17. The method of claim 1, additionally comprising obtaining measurements for each of the abnormalities based on the obtained information pertaining to the region of suspicion taken from the plurality of image data sets.

18. The method of claim 1, additionally comprising counting the number of regions of suspicion that have been determined to be abnormalities.

19. The method of claim 1, wherein the plurality of image data sets includes a first scan taken at a first time and a second scan taken at a second time after the first time, the method additionally comprising the step of determining how one or more abnormalities have changed from the first time to the second time.

20. A method for automatic detection of bone lesions within a computer aided detection system, comprising:
acquiring a plurality of image data sets including multiple image scans and multiple data sequences;
segmenting one or more bones within one or more of the image data sets;
co-registering each of the image data sets to a common coordinate system with reference to the one or more bones;
individually examining each image data set to identify the location of one or more lesion candidates with reference to the common coordinate system within one or more of the image data sets;
individually inspecting each of the image data sets at the locations of the identified lesion candidates on the common coordinate system to obtain information pertaining to each of the lesion candidates;
determining, based on the obtained information pertaining to the lesion candidates, whether each of the lesion candidates is an actual lesion; and
categorizing each lesion candidate that has been determined to be an actual lesion according to the obtained information pertaining to the lesion candidates.

21. The method of claim 20, wherein the plurality of image scans includes a coronal scan and a saggital scan.

22. The method of claim 20, wherein the one or more bones is a spinal column and the lesion candidates are spinal lesion candidates.

23. The method of claim 20, wherein intensity inhomogeneity correction is performed on each image data set after the plurality of image data sets are acquired and before the one or more bones are segmented.

24. A computer system comprising:
a processor; and
a program storage device readable by the computer system, embodying a program of instructions executable by the processor to perform method steps for automatic detection of bone lesions, the method comprising:
acquiring a plurality of image data sets including multiple image scans and multiple data sequences;
individually examining each image data set to identify the location of one or more lesion candidates with reference to the common coordinate system within one or more of the image data sets;
individually inspecting each of the image data sets at the locations of the identified lesion candidates on the common coordinate system to obtain information pertaining to each of the lesion candidates; and
determining, based on the obtained information pertaining to the lesion candidates, whether each of the lesion candidates is an actual lesion.

25. The computer system of claim 24, wherein each of the image data sets are segmented to a common coordinate system with reference to the one or more bones before individually examining each image data set to identify the location of one or more lesion candidates.

26. The computer system of claim 25, wherein intensity inhomogeneity correction is performed on each image data set after the plurality of image data sets are acquired and before the one or more bones are segmented.

27. The computer system of claim 24, additionally comprising categorizing each lesion candidate that has been determined to be an actual lesion according to the obtained information pertaining to the lesion candidates.
